(19) United States
(12) Patent Application Publication
(10) Pub. No.: US 2009/0233054 A1
(43) Pub. Date: Sep. 17, 2009

(54) Material Curing Constructions and Methods for Curing Material

(76) Inventor: Brent Condie, Worley, ID (US)

Correspondence Address: WELLS ST. JOHN P.S., 601 W. FIRST AVENUE, SUITE 1300, SPOKANE, WA, 99201, US

(21) Appl. No.: 12/404,927

(22) Filed: Mar. 16, 2009

Related U.S. Application Data
(63) Continuation-in-part of application No. 11/977,503, filed on Oct. 24, 2007.
(60) Provisional application No. 61/069,361, filed on Mar. 14, 2008.

(51) Int. Cl. B32B 13/14; B29C 65/02; B32B 3/02

(52) U.S. Cl. 428/192; 442/42; 156/304.2

(57) ABSTRACT

Multi-layer concrete forms are provided that can include outer layers having a scrim layer there between. The forms may include a form section having four edges, wherein at least two of the edges are configured to abut one another; and a flange section extending from at least one of the other four edges. Processes for constructing a concrete form are provided with the process including providing a substantially flat section of form to a construction site, with the section having four edges; substantially abutting at least two of the edges to create a tubular form; and heat sealing the edges.

### RELATED APPLICATIONS

This application is a continuation-in-part of U.S. Non-Provisional patent application Ser. No. 11/977,503 filed Oct. 24, 2007 and entitled “Material Curing Constructions and Methods for Curing Material.” This application also claims priority under 35 U.S.C. §119 to U.S. Provisional Patent Application Ser. No. 61/069,361 filed Mar. 14, 2008 and entitled “Material Curing Constructions and Methods for Curing Material.”

### TECHNICAL FIELD

The present disclosure relates to the curing of materials and more particularly construction materials such as concrete.

### BACKGROUND

Cured construction materials such as concrete play an important, if not necessary, role in modern construction. However, the use of concrete can limit the architectural features of a construction, leaving the building cold and aesthetically displeasing.

### SUMMARY OF THE DISCLOSURE

Form inserts are provided that can include a flexible sheet having multiple ribs extending from at least one surface of the sheet.

Methods for curing material within a form are provided that can include expanding a sheet over an interior portion of one form defining a perimeter of material to be cured. The sheet can include ribs extending from a surface of the sheet to within the perimeter. The material to be cured can be provided to within the form, with the material receiving at least a portion of the ribs of the sheet. The material can be cured, and the sheet removed from the cured material.

Column form inserts are also provided that can include a plurality of circular ribs defining a perimeter of a column form. The ribs can be coupled to one another by interconnecting members to form a frame, for example.

A method of producing a form insert is also provided that can include providing a sheet of flexible material and adhering a flexible mesh to the sheet, with the flexible mesh forming ribs extending from at least one surface of the sheet.

### BRIEF DESCRIPTION OF THE DRAWINGS

Embodiments of the disclosure are described below with reference to the following accompanying drawings.

FIG. 1 is a form insert and orchestration of use of same according to an embodiment.

FIG. 2 is form insert production apparatus according to an embodiment.

FIG. 3 is form material according to an embodiment.

FIG. 4 is a form insert and orchestration of use of same according to an embodiment.

FIG. 5 is a detail of a coupled form insert according to an embodiment.

FIG. 6 is a form insert according to an embodiment.

FIG. 7 is a form insert and orchestration of use of same according to an embodiment.

FIG. 8 is a form according to an embodiment.

FIG. 9 is another view of the form of FIG. 8 according to an embodiment.

FIG. 10 is a form according to an embodiment.

FIG. 11 is a form according to an embodiment.

FIG. 12 is a form according to an embodiment.

FIG. 13 is a form according to an embodiment.

FIG. 14 is a form according to an embodiment.

### DESCRIPTION

This disclosure is submitted in furtherance of the constitutional purposes of the U.S. Patent Laws “to promote the progress of science and useful arts” (Article 1, Section 8).

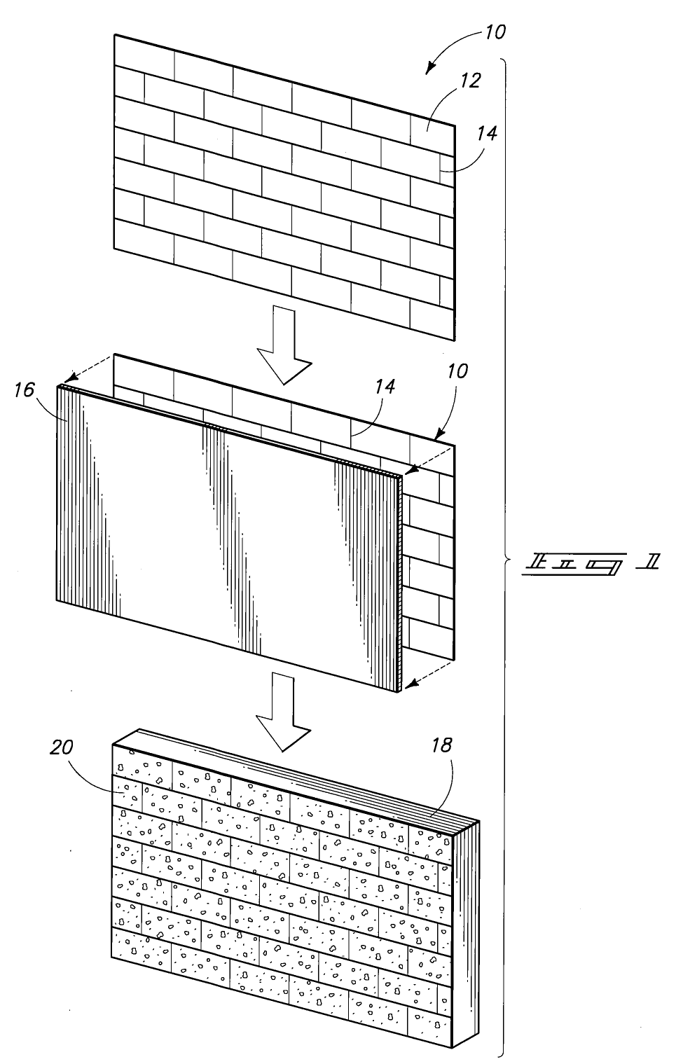

Material curing constructions and methods for curing material are provided with reference to FIGS. 1-14. Referring to FIG. 1, curing construction 10 is shown that includes a flexible sheet 12 having multiple ribs 14 extending from at least one surface of the flexible sheet. Sheet 12 can be constructed of a polymeric material such as polyethylene. Sheet 12 may be from about 3 mils to about 20 mils in thickness. Sheet 12 may also be a scrim reinforced film. Ribs 14 can also be constructed of a polymeric material such as polyethylene/EPTM. Ribs 14 may extend from the surface of flexible sheet 12 a sufficient amount to engage a material to be cured and form a depression therein upon removal of construction 10 from the cured material. Ribs 14 can extend from about 1/16 inch to about ½ inch. According to an example embodiment, ribs 14 are configured to form a mesh of material, and according to another example embodiment, ribs 14 can be configured to form a decorative pattern. In another embodiment, ribs 14 can be configured to form an architectural feature.

Referring to FIG. 1, construction 10 can be expanded over an interior portion of one form defining a perimeter of a material to be cured. Consistent with the field of art, forms can be used to define a boundary for curing materials such as concrete or any other building construction materials. In this embodiment, the form consists of a semi-, or almost completely flat substrate that forms a perimeter of the material to be cured. As is shown in FIG. 1, construction 10 can be placed against form 16, and construction 10 can be configured with ribs 14 extending from a surface of the sheet within the perimeter defined by the form. In accordance with exemplary methods of curing material, material to be cured within the form can be provided, and the material can receive at least a portion of ribs 14 of sheet 10. The material can then be cured and the sheet removed from the material.

Referring to FIG. 1 again, upon removal of construction 10, ribs 14 provide openings 20 within cured material 18. According to an additional example embodiment, additional materials can be provided between the material to be cured and construction 10 to provide even more additional architectural features. For example, these materials can be provided to demonstrate peaks and/or valleys within the material. Exemplary materials include corrugated paper, for example, or any rough surface materials that can imprint an architectural feature.

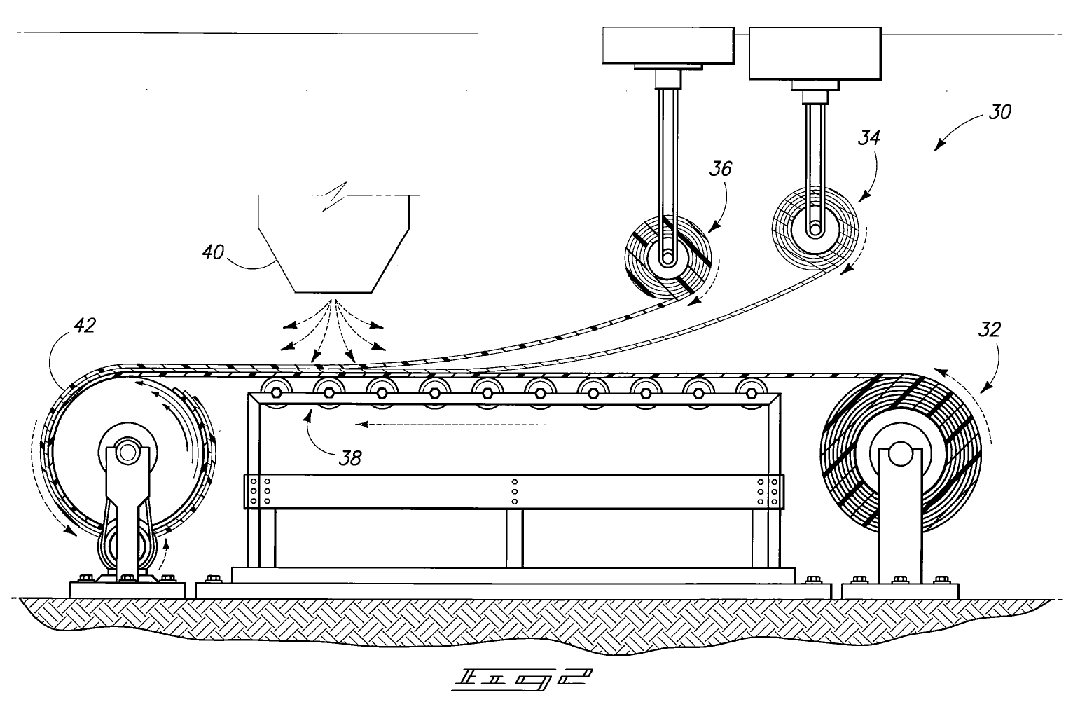

Referring to FIG. 2, an example apparatus 30 for preparing construction 10 is shown. Apparatus 30 can include at least two feed rollers, or as shown, at least three feed rollers. Feed rollers 32, 34, and 36 can be operatively configured across forming bed 38, which can be placed below ceiling apparatus 40, and then upstream of receiving roll 42. According to an exemplary embodiment, apparatus 30 can be used to produce a form insert, and part of the construction can include providing a sheet of flexible material from roller 32 and adhering a flexible mesh from roller 34 to the sheet. According to an exemplary embodiment, the flexible mesh can form ribs extending from at least one surface of the sheet. The adhering process can be formed utilizing adhering apparatus 40. For example, adhering apparatus 40 can be a heat supply that melts pliable polymeric material from roller 32 engaging mesh material from roller 34. Alternatively, mesh material 34 can be pliable and adhere to flexible material 32 utilizing adhering apparatus 40. According to an example embodiment, at least one of the two rolls of material to be adhered together can be oriented above the other rolls of material. For example, roll 34 can be oriented above roll 32 in relation to forming bed 38. According to another embodiment, the adhering process can encase mesh from roll 34 within the flexible material from roll 32.

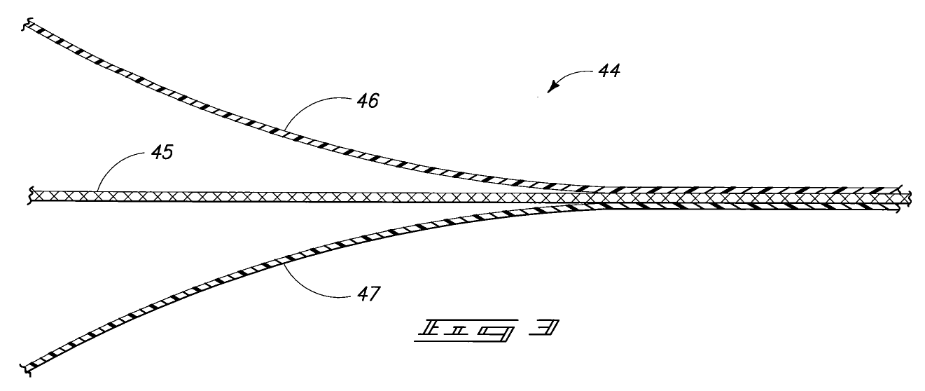

Referring to FIG. 3, an example sheet 44 is shown that includes scrim material 45 within polymeric materials 46 and 47. Scrim material 45 can include a webbing such as nylon or even cotton webbing. Polymeric materials 46 and 47 can either or both be polyethylene, for example.

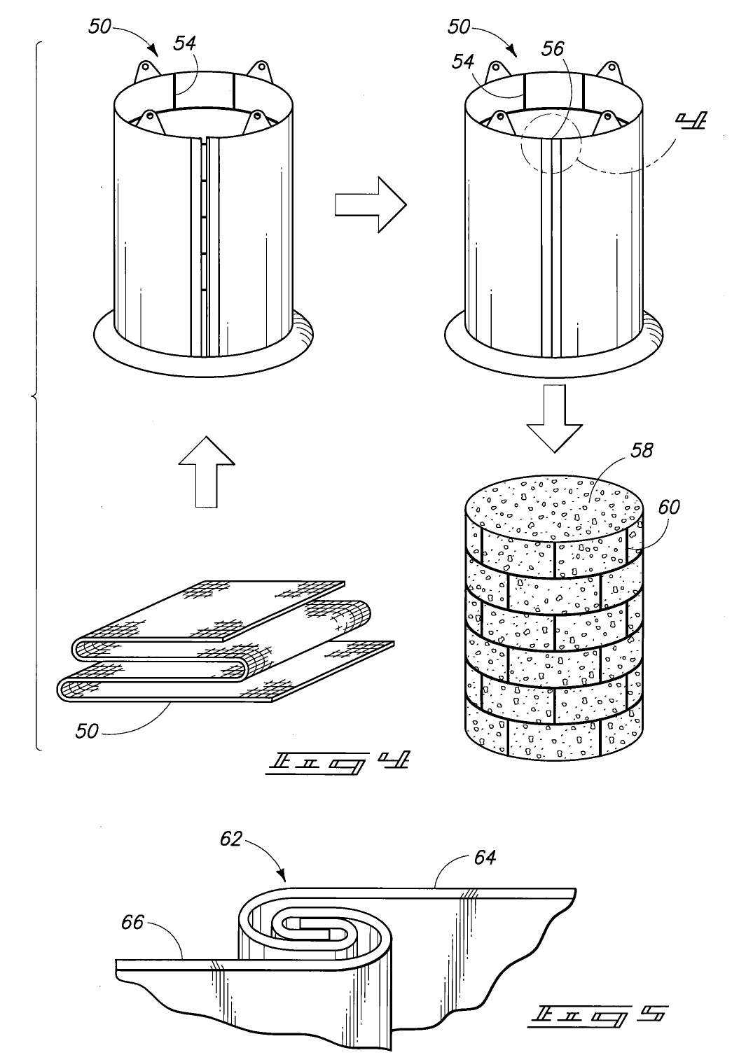

Referring to FIGS. 4 and 5, another embodiment of the present disclosure is provided. Form insert 50 can be configured to be provided in folded sheets, for example, to conserve storage space at the construction site. As such, these sheets can be stacked on top of one another and stored away in relatively small spaces until needed for use. Sheets 50 can then be unfolded and then aligned in a cylindrical fashion and as aligned, they can form an insert to be provided within a form to house material to be cured. As an example embodiment, forms 50 can include ribs 54 defining a perimeter of the columnar form. The ribs can be coupled to one another by interconnecting members to form a frame. For example, opposing ends of form 50 can be coupled to one another to form a cylindrical construction. As such, upon material curing, columns can be provided that can include architectural features such as indentations outlining a brick construction. Indentations 60 can be consistent with ribs 54, for example.

Referring to FIG. 5, another example embodiment for the coupling of opposing ends of material 50 is shown. As can be seen, portion 66 of material 50 can form a complimentary hook portion to a hook portion of portion 64 of material 50. These hooks can be aligned together and compliment one another, engaging one another at portion 62, for example.

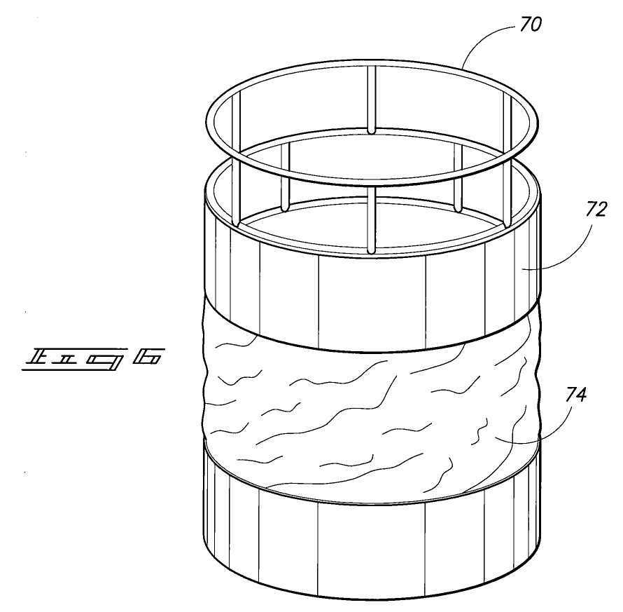

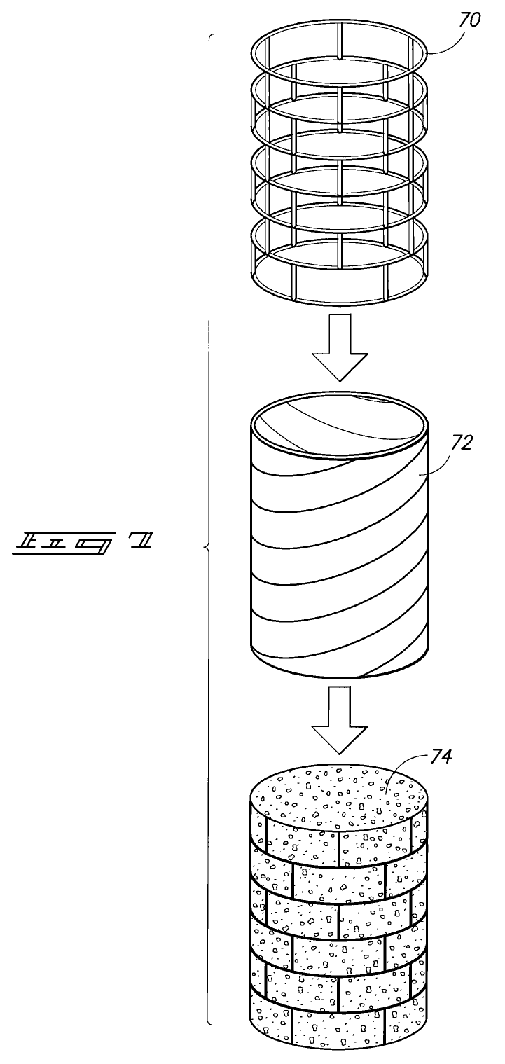

Referring to FIG. 6, and still another embodiment, construction 70 can include a frame or mesh of ribs that can be aligned within a form 72 having cured material therein. According to an exemplary embodiment and referring to FIG. 7, construction 70 can be placed within a form 72 and then upon curing of material 74, the construction 70 can be removed, as well as form 72, to provide a column 74 of the cured material having exposed architectural features.

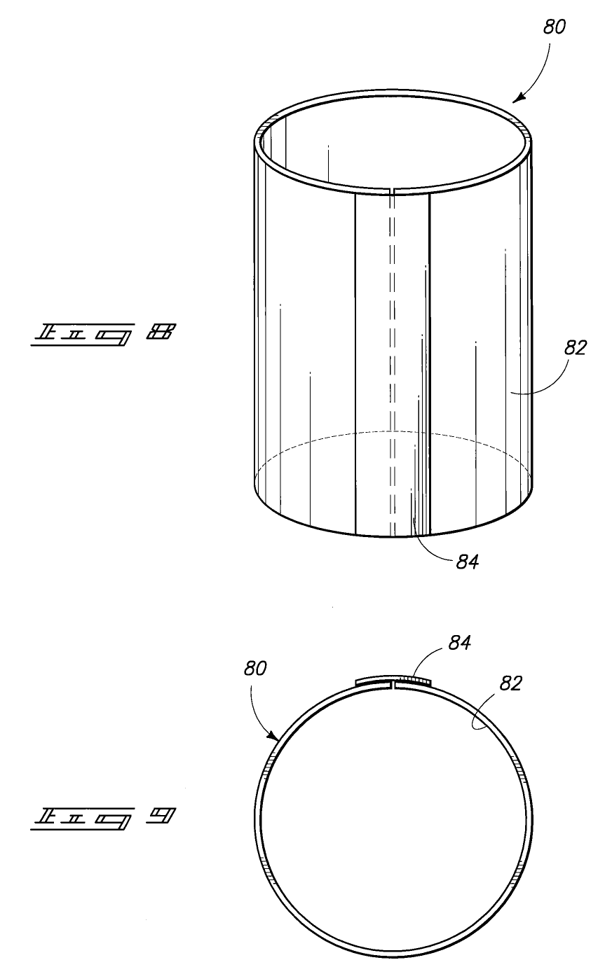

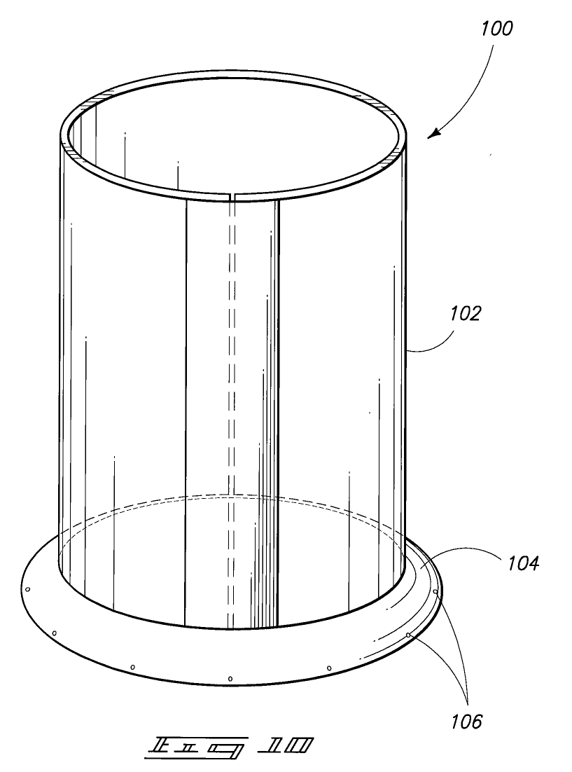

Referring to FIGS. 8 and 9 another form embodiment is shown as form 80. Form 80 can be comprised of scrim reinforced film 82. The film can have a scrim of a fabric such as nylon and polymeric component such as polyurethane, polyvinylchloride, and/or polyethylene. The sheet may be able to withstand tensile loads of 1,000 psi without bursting.

Referring to FIG. 9, form 80 may be formed using heat sealing. For example, seal tape 84 may be applied to abutting ends of film 82, and heat applied to couple abutting ends of film 82 constructing a tubular form. At least some advantages utilizing embodiments of these forms include:
the film of the form can be folded, cut and reused between construction jobs with limited clean up and without application of release agents;
the film is much stronger than the pressed board currently used; and
the film leaves a smooth finish surface according to example applications.

Furthermore, form 80 of film 82 can be self-supporting without additional supporting material. However, with reference to FIG. 10 an embodiment is depicted that includes form 100 constructed of film 102 having support material 104 extending therefrom. According to example embodiments, material 104 can be a scrim reinforced film as well and can be coupled to a lower portion of form 100. Material 104 can be hot melted, sewn, or even latched to the lower portion. In the shown embodiment, material 104 extends the entire perimeter defined by the lower portion. However, alternative embodiments are contemplated in which a plurality of individual members extend from the lower portion. Openings 106 can be in material 104 and configured to receive spikes that may facilitate the coupling of the form to the surface which may further facilitate the self-support of form 100.

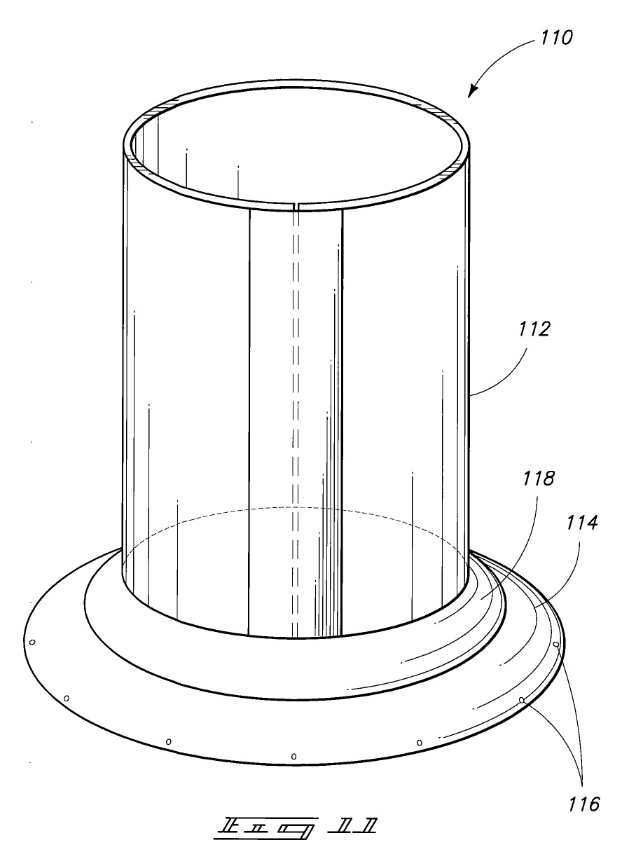

Referring to FIG. 11 another embodiment of the form of the present disclosure is provided with reference to form 110 which includes a taper portion 118 between material 114 and film 112. Portion 118 can facilitate the formation of an additional supportive footing when preparing concrete pillars using form 100.

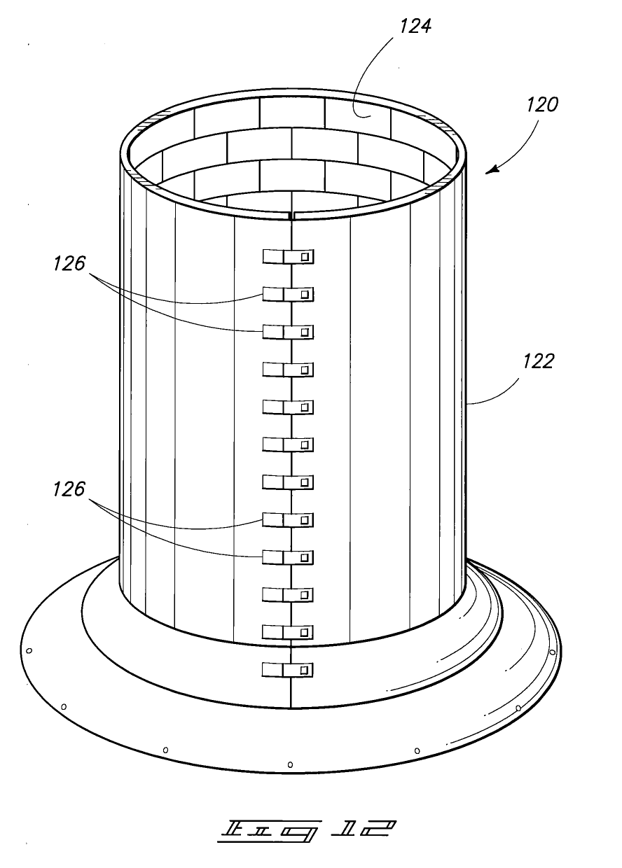

Referring to FIG. 12, yet another embodiment of the form of the present disclosure is provided with reference to form 120 which includes architectural decorative material 124 within film 122. Form 120 is also coupled to construct a cylindrical form with metal latches 126. Complimentary portions of latches 126 can be affixed to opposing abutting ends of film 122 and clasp to construct a cylinder.

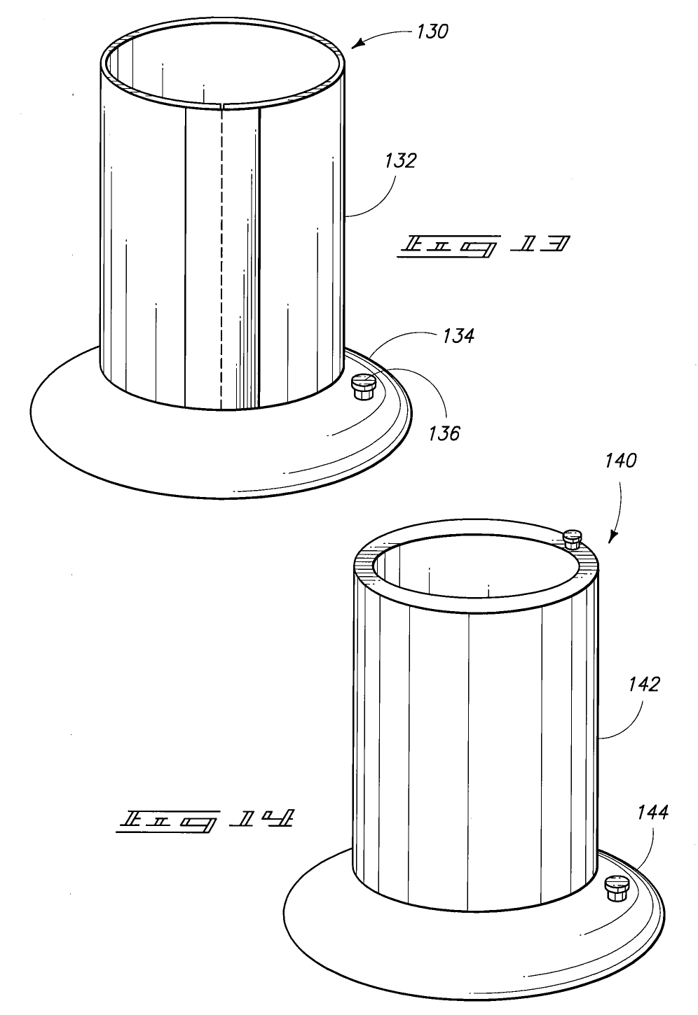

Referring to FIGS. 13 and 14 still additional embodiments of the disclosed forms are depicted. Referring to FIG. 13 form 130 includes film 132 coupled to base 134. Base 134 can also be constructed of scrim reinforced polymer but base 134 is configured to contain support/ballast materials such as water and/or sand. Ballast materials may be provided to within opening 136 to fill a void between the configured film of base 134. Referring to FIG. 14, both film 142 and base 144 of form 140 may be configured to contain water and or sand to further stabilize form 140.

With reference to an additional embodiment, form 120 can be configured with both upper (not shown) and lower flanges. These flanges can include openings aligned between the flanges to receive plates. Individual supports, such as posts can be configured to extend between the plates and support form 120 in its upright configuration.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

What is claimed is:

1. A multi-layer concrete form comprising outer layers having a scrim layer there between.

2. The form of claim 1 wherein at least one of the outer layers comprises a polymeric material.

3. The form of claim 1 wherein the scrim layer comprises woven polymeric material.

4. The form of claim 1 wherein the outer layer comprises polyethylene.

5. A process for constructing a concrete form, the process comprising:
providing a substantially flat section of form to a construction site, the section having four edges;
substantially abutting at least two of the edges to create a tubular form; and
heat sealing the edges.

6. The process of claim 5 further comprising separating the heat sealed edges to return the tubular form to the substantially flat section.

7. The process of claim 5 wherein the section comprises multiple layers.

8. The process of claim 5 wherein the section comprises a polymeric material.

9. The process of claim 5 wherein the section comprises one or more of polyurethane, polyvinylchloride, and polyethylene.

10. A multi-layer concrete form comprising:
a form section having four edges, wherein at least two of the edges are configured to abut one another; and
a flange section extending from at least one of the other four edges.

11. The form of claim 10 wherein the form section comprises a scrim component.

12. The form of claim 10 wherein the flange section includes openings configured to receive support spikes.

13. The form of claim 10 wherein the flange section includes a tapered portion configured to provide additional concrete form.

14. The form of claim 10 wherein the flange section is configured to receive ballast therein.

15. The form of claim 10 wherein the ballast can be sand.

16. The form of claim 10 wherein the ballast can be water.
